(19) United States
(12) Patent Application Publication
(10) Pub. No.: US 2026/0195123 A1
(43) Pub. Date: Jul. 9, 2026

(54) EMBEDDED SOFTWARE DEVELOPMENT USING CONTINUOUS INTEGRATION THROUGH A PIPELINE AGENT

(71) Applicant: Steering Solutions IP Holding Corporation, Saginaw, MI (US)

(72) Inventors: Grant Adkins, Lake Orion, MI (US); Michael F. Mackay, Birmingham, MI (US); Keyur R. Patel, Rochester, MI (US); Jared Julien, Bay City, MI (US)

(21) Appl. No.: 19/441,570

(22) Filed: Jan. 6, 2026

Related U.S. Application Data
(60) Provisional application No. 63/743,011, filed on Jan. 8, 2025.

(51) Int. Cl. G06F 8/71

(52) U.S. Cl. CPC G06F 8/71

(57) ABSTRACT

A method for performing integrated software development of a software product including a plurality of individual software components includes, using one or more processors, receiving an indication that a change was made to a first software component of the plurality of individual software products, in response to the indication, automatically updating an architecture definition associated with the first software component based on the change made to the first software component, updating an architecture of the software product based on the change made to the first software component, compiling the software product, and publishing build artifacts associated with the software product.

### CROSS-REFERENCE TO RELATED APPLICATIONS

This application claims the benefit of U.S. Provisional Application No. 63/743,011, filed on January 8, 2025. The entire disclosure of the application referenced above is incorporated herein by reference.

### TECHNICAL FIELD

This disclosure relates to software architecture for developing and integrating software applications.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like. Steering and other automotive systems require development, integration, and implementation of various software components and applications.

### SUMMARY OF THE INVENTION

The present disclosure generally relates to integrated software development processes.

A method for performing integrated software development of a software product including a plurality of individual software components includes, using one or more processors, receiving an indication that a change was made to a first software component of the plurality of individual software products, in response to the indication, automatically updating an architecture definition associated with the first software component based on the change made to the first software component, updating an architecture of the software product based on the change made to the first software component, compiling the software product, and publishing build artifacts associated with the software product.

Other aspects include systems, computing devices, one or more processors, etc. configured to perform functions related to the methods described herein.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates a controller according to the principles of the present disclosure.

FIG. 1C generally illustrates an embedded software development process.

FIG. 2 generally illustrates an example embedded software development process that implements a continuous integration pipeline and associated techniques according to the principles of the present disclosure.

FIG. 3 generally illustrates an example pipeline process for changes to an individual software component according to the principles of the present disclosure.

FIGS. 4A and 4B generally illustrate an example pipeline process for architectural changes according to the principles of the present disclosure.

FIG. 5 generally illustrates an example computing device configured to implement various aspects of the pipeline process according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Systems and methods of the present disclosure are configured to facilitate embedded software development (e.g., development of a software product, file, infrastructure, etc. comprising a plurality of individual software components) by implementing continuous integration pipeline techniques. For example, a series of scripts are implemented to leverage the functionality of continuous integration pipelines (Microsoft Azure Pipelines, GitLab, Jenkins, etc.) to automate portions of the software development process. Multiple different processes or procedures are automated dependent upon actions of one or more users. The different processes are executed using a pipeline agent configured to perform various integration steps and publish/output results of the integration.

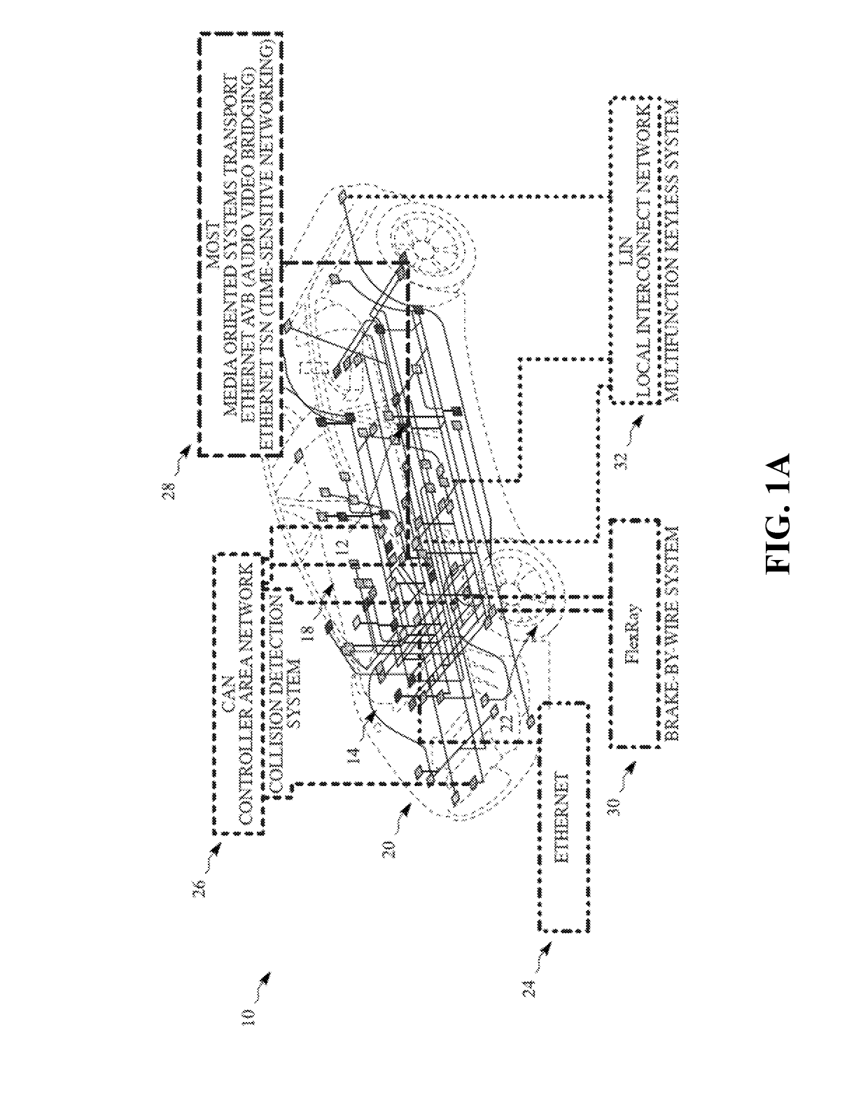

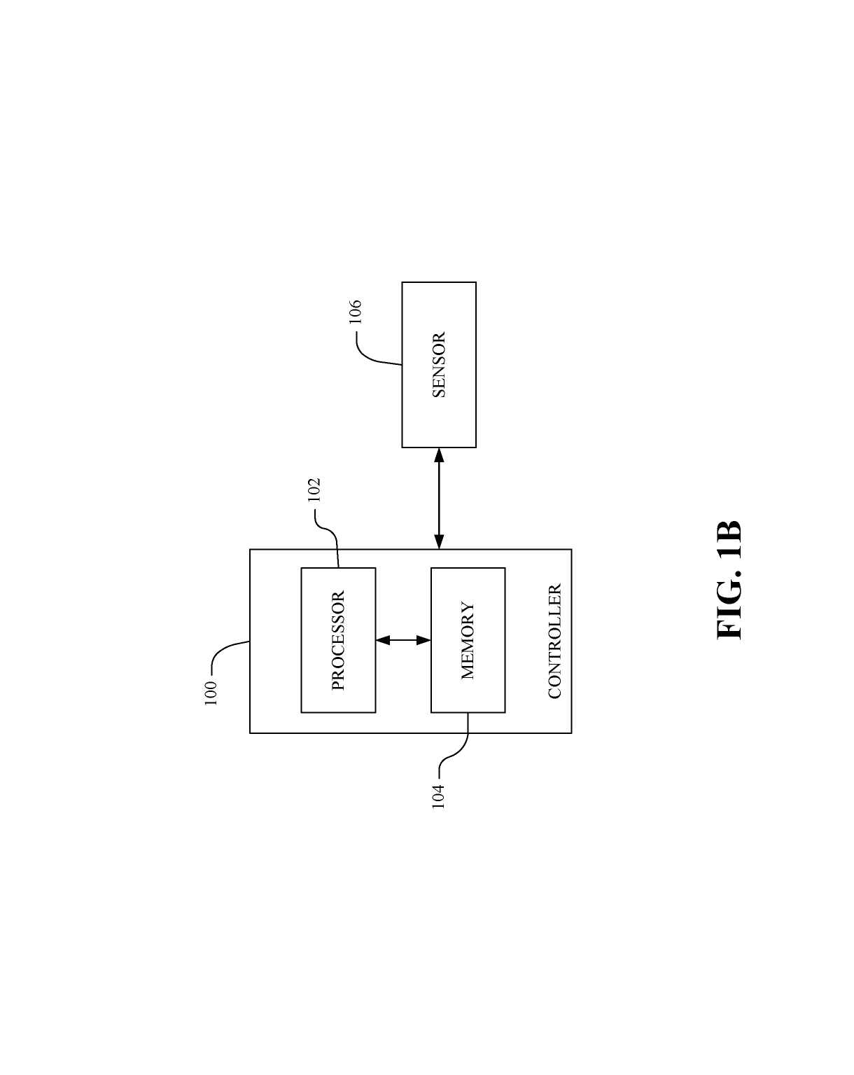

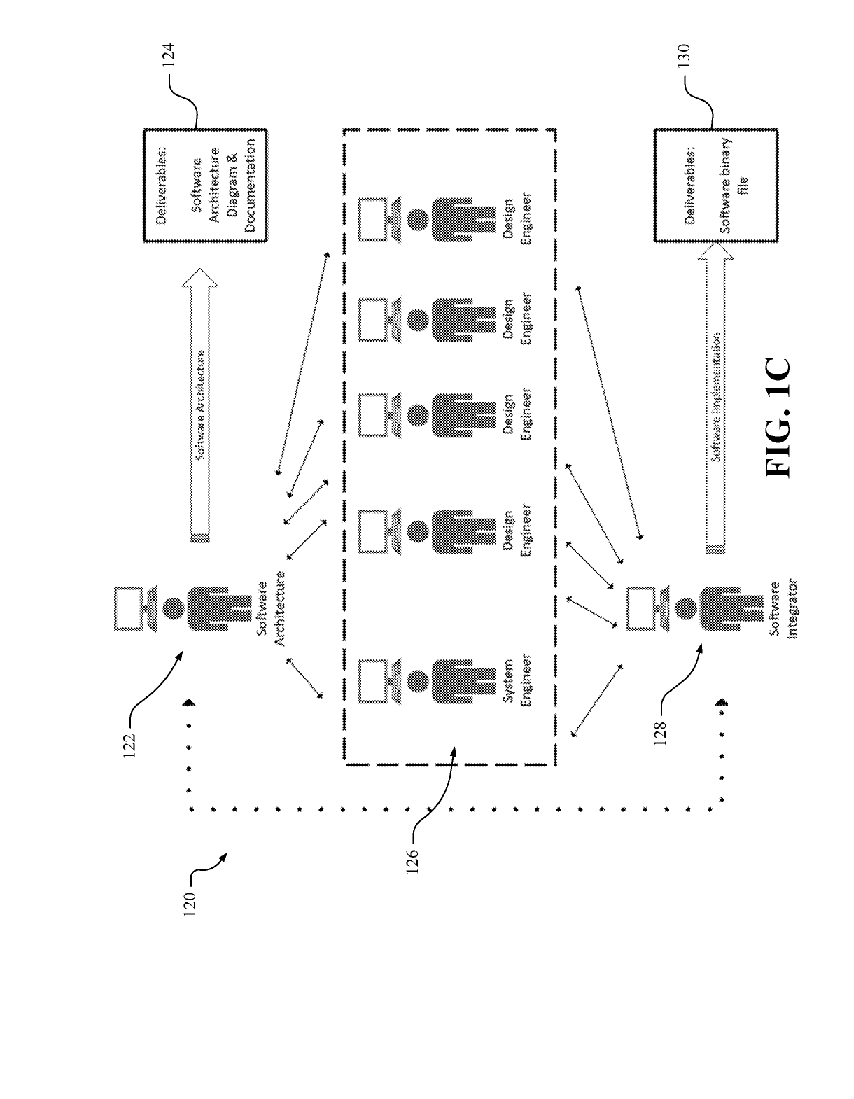

FIG. 1A generally illustrates a vehicle 10 according to the principles of the present disclosure. The vehicle 10 may include any suitable vehicle, such as a car, a truck, a sport utility vehicle, a minivan, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles. The vehicle 10 is provided simply as an example of one type of system configured to implement and/or be controlled using software developed in accordance with the principles of the present disclosure.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

In some embodiments, the vehicle 10 includes one or more controllers, such as controller 100, as is generally illustrated in FIG. 1B. The controller 100 may correspond to a steering system controller. The controller 100 may include any suitable controller, such as an electronic control unit or other suitable controller. The controller 100 may be configured to control, for example, the various functions of the steering system and/or various functions of the vehicle 10. The controller 100 is provided simply as an example of one type of controller or device configured to implement and/or be controlled using software developed in accordance with the principles of the present disclosure.

The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof.

As used herein, “controller” may refer to a hardware module or assembly including one or more processors or microcontrollers, memory, sensors, one or more actuators, a communication interface, etc., any portions of which may be collectively referred to as “circuitry.” As described herein, respective functions and steps performed by a given controller, control circuitry, etc. may be collectively performed by multiple controllers, processors, etc. For example, a processor, processing device, controller, control circuitry, etc. “configured to perform” may refer to a single processor, processing device, controller, etc. configured to perform both A and B or may refer to a first processor, processing device, controller, etc. configured to perform A and a second processor, processing device, controller, etc. configured to perform B. For simplicity, “control circuitry configured to perform A and B” may refer to a single or multiple processors, processing devices, controllers, etc. collectively configured to perform A and B.

Software design and integration processes (e.g., for software implemented by the vehicle 10 and/or components of the vehicle 10, software used for manufacture of the vehicle 10, etc.) are typically complex, lengthy, and inefficient. For example, as shown in FIG. 1C, a traditional embedded software development process 120 includes a plurality of manual inputs, steps, etc., with numerous individuals/entities (e.g., software, system, or design engineers, programmers, etc.) developing and passing deliverables to one via at respective computing devices. As such, considerable coordination between entities is required, resulting in a lengthy and sometimes unwieldy development cycle. For example, a first individual or entity (e.g., a software architect as shown at 122) defines an outline of a software component and how the software component fits into the larger architecture of an individual software project (e.g., shown as a software architecture diagram at 124). Conversely, one or more second entities develop the functionality of the software component (e.g., various engineers, as shown at 126), and a third entity (e.g., a software integrator as shown at 128) integrates the software component into the project (e.g., shown schematically at 130 as a software file), as defined by the software architect 122. This process occurs without a clear or robust system for sharing files amongst the team members or providing traceability to each other or others in an organization. Further, this process can be delayed at various points or steps, such as delays caused by the amount of time required to upload and download portions or the entirety of a software project. As another example, the process can fail for various reasons, such as a lack of a common changelog for projects.

Furthermore, there is a limit to the amount of parallel work that can be completed in an organization. Current software integration processes, for example, require special software tools with expensive licensing fees. Therefore, the number of engineers with the appropriate licenses is kept to a minimum, limiting the amount of work that can be done across all projects in an organization.

Software design and integration systems and methods (e.g., for software implemented by the vehicle 10 and/or components of the vehicle 10, software used for manufacture of the vehicle 10, etc.) according to the principles of the present disclosure facilitate embedded software development by implementing continuous integration pipeline techniques as described below in more detail.

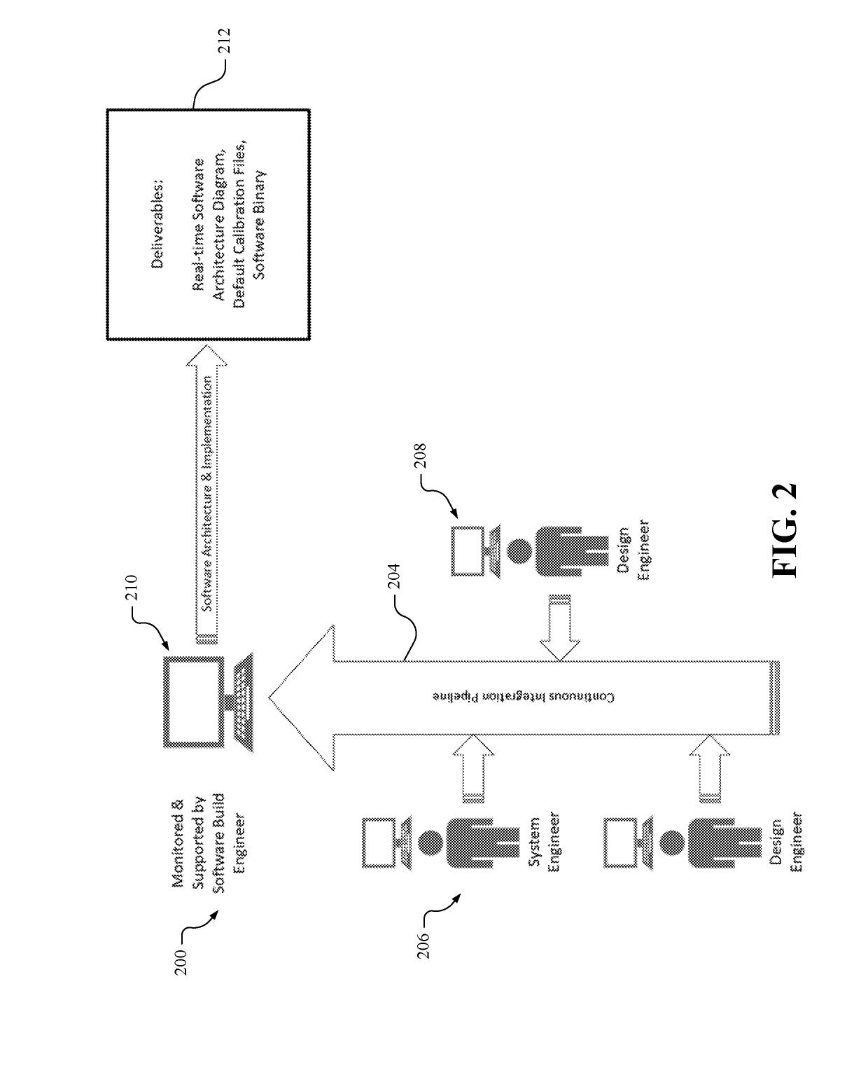

FIG. 2 shows an example embedded software development process 200 that implements a continuous integration pipeline 204 and associated techniques according to the present disclosure. Users (e.g., software design and/or other engineers, as shown at 206) provide respective contributions (e.g., individual software components) to the process 200 via the pipeline 204 (e.g., via respective processing devices, computing devices, associated user interfaces, etc., as shown at 208). A pipeline agent (e.g., implemented by one or more processors, computing devices, etc. as shown at 210) executes different processes to integrate the individual components of the various engineers to publish integrated results 212 (e.g., a software architecture diagram, calibration files, a software binary file, etc.).

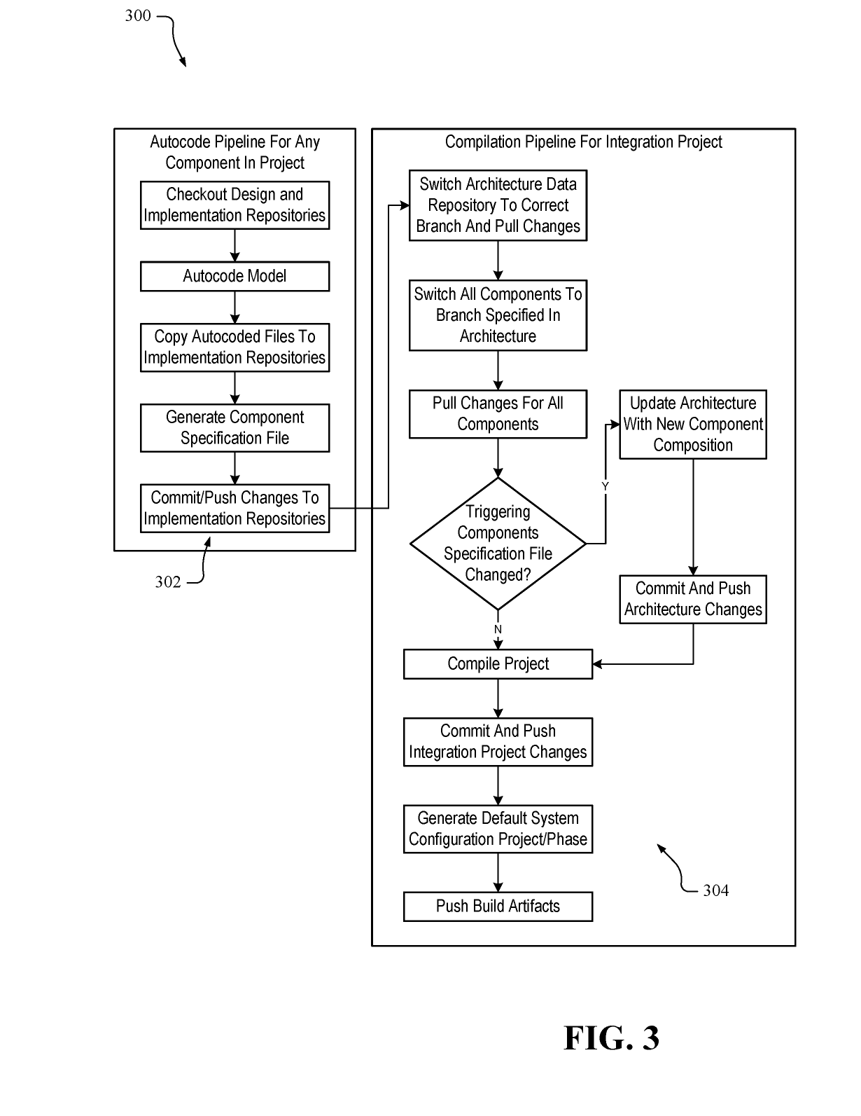

FIG. 3 generally illustrates an example pipeline process 300 for performing changes to an individual software component according to the principles of the present disclosure. For example, if a user is working on the design of an individual software component, then when the changes are committed to an implementation repository (e.g., a Git repository) for that component as shown at 302, the server will automatically pull in the latest changes to the design (e.g., a Matlab design of the software component), automatically autocode the software component, generate a specification component file (e.g., generate .arxml file, an example standard file for component specifications, which can be used in various development tools, using a repository of metadata, such as a data dictionary (DataDict)), and insert the newly changed source code to the integration project, which is then compiled and, upon success, committed to the integration project’s repository (as shown at 304). As used herein, the “server” may correspond to one or more local or remote computing devices, a cloud computing system, etc., which can be represented schematically by the computing device 210 of FIG. 2.

In an example, the process 300 includes, using one or more processors: receiving an indication that a change was made to a first software component of the plurality of individual software products (e.g., as triggered by changes being committed and pushed to the implementation repository); in response to the indication, automatically updating an architecture definition associated with the first software component based on the change made to the first software component; updating an architecture of the software product based on the change made to the first software component; compiling the software product; and publishing build artifacts associated with the software product.

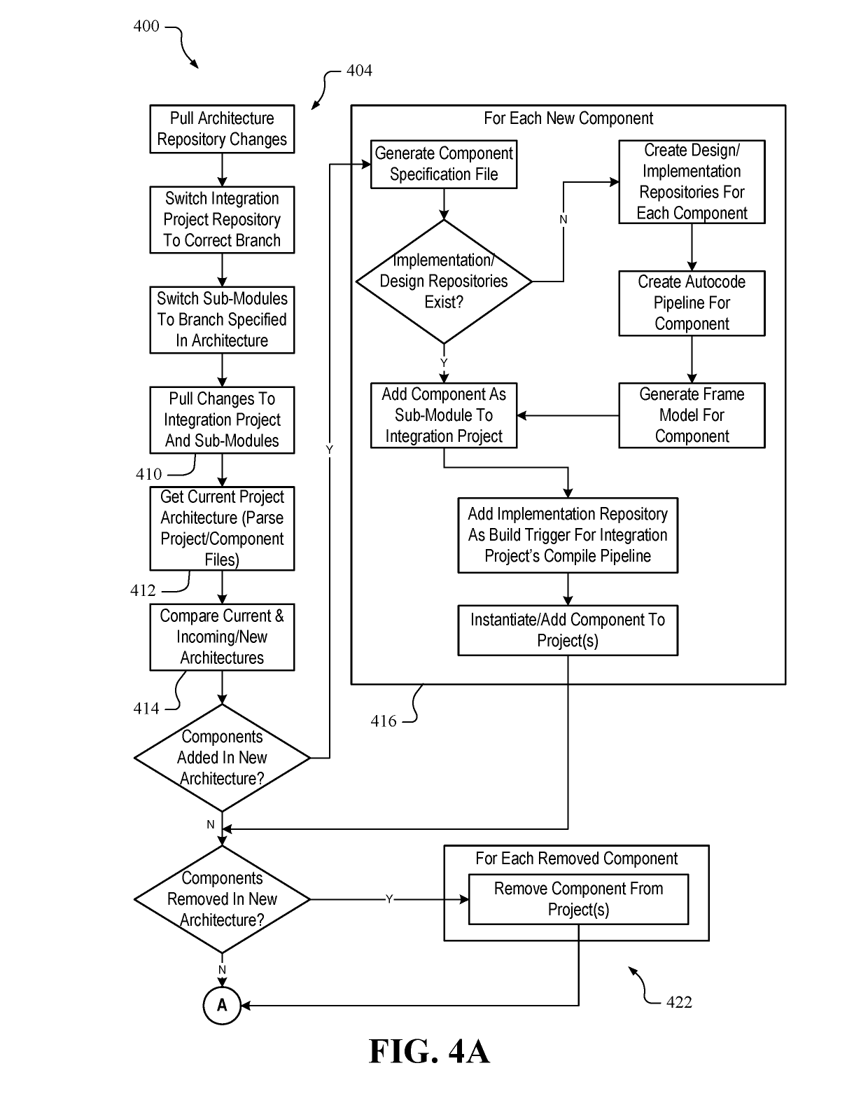

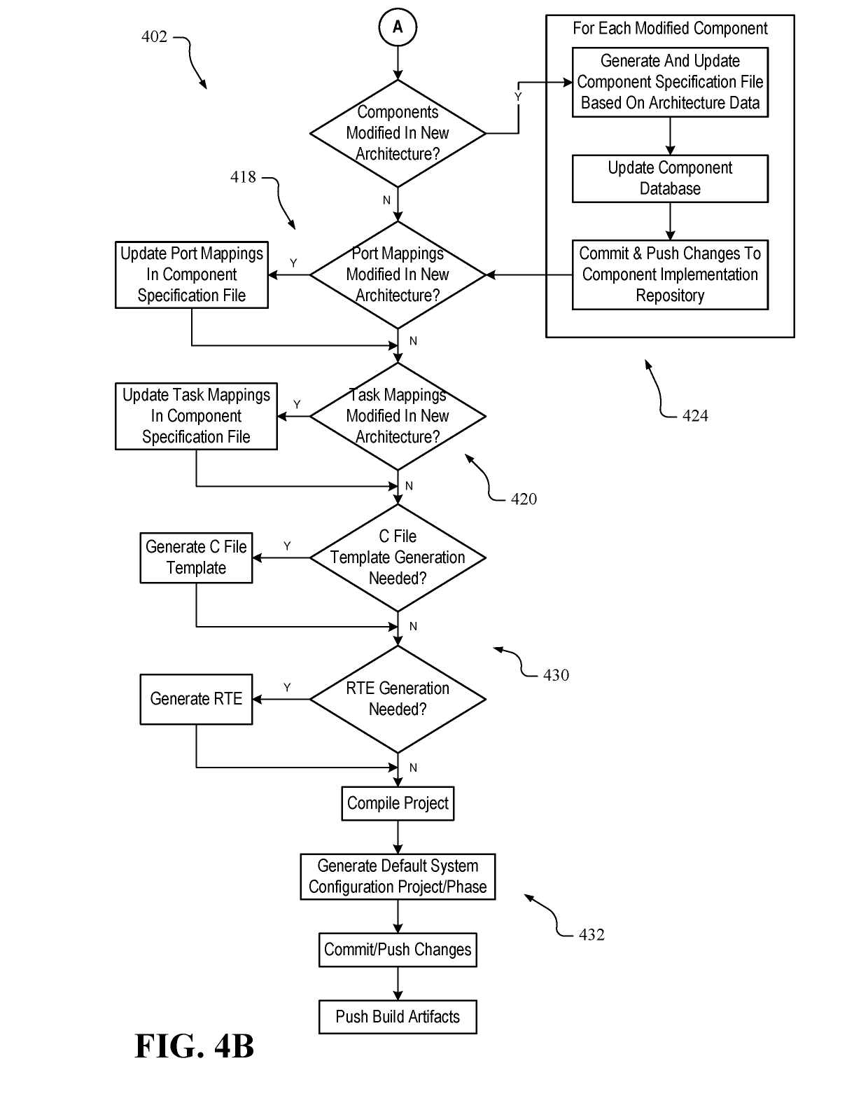

FIGS. 4A and 4B generally illustrate an example pipeline process 400, 402 for performing architectural changes (e.g., in contrast to changes to an individual component as described in FIG. 3) according to the principles of the present disclosure. By hosting the software components’ code in their own individual repositories, the software components can be treated as modular units that can be slotted into one or more integration projects. Accordingly, in combination with the autocoding pipelines detailed above in FIG. 3, changes to a component can automatically be distributed across multiple integrations projects, allowing a designer to have multiple compiled binaries containing their changes available to test across multiple projects and product lines within a few minutes. This is a considerable improvement to the traditional process where the component designer makes a change and sends the change to the integrator (often through an instant message or email rather than through a central repository with robust tracking), who then autocodes the change on their local computing device and then manually adds the code to all requisite integration projects and manually triggers compilation. This process also greatly improves traceability, with every change having a message and the person who made the change listed in a single location that all users can access within the repository.

Support for changes that directly affect the software project’s architecture is also provided. By defining the project’s architecture in a repository of its own that is directly linked to the integration project, we can trigger changes in the integration project based on the changes made to the architecture repository (as shown at 404). Similar to the above autocoding pipeline, a different pipeline is triggered on a commit to the architecture repository. In this pipeline, the server automatically pulls in the latest version of the architecture specification (as shown at 410) and then parses through all the component specification (e.g., .arxml) files in the integration project to obtain the current state of the project’s architecture (as shown at 412). The current and changed/incoming architectures are then compared (as shown at 414) to obtain a list of changes. The list of changs is used to increase the overall efficiency of the pipeline, ensuring that only the necessary steps are required when code generation is performed later in the process.

If a component is included in the new architecture that does not currently exist in the integration project, then all available component repositories are first checked. If the requested component is found, then that component’s repository is added to the broader integration project repository as a sub-module, creating a link that will allow for the above autocoding pipelines to work for this project and adding the component’s source code to the integration project. If there is not an existing repository for the component in the source control system, then a new one is created based on the specifications in the incoming architecture. This newly created repository has everything that a component owner needs to develop their component, an initial .arxml file for the component, a template Matlab model with auto coding capabilities, a template source file containing empty function definitions for the component’s runnables and a pipeline already set up to auto code the component on the server upon commits to the newly created component. This newly created component is also added to the integration project, again with all the auto coding pipelines configured automatically. The above processes associated with adding a new component are shown schematically at 416.

Any differences in the port mappings (e.g., the way that the data flows through the different software components) are and the script automatically makes changes to the various .arxmls within the integration project that deal with port mappings as shown at 418. A similar process is done for changes to the task mappings (the order in which the functions for all the different software components are called) as shown at 420. Further, if there are components removed from the project’s architecture, then the script removes those components from the integration project as shown at 422. Modified components (e.g., components that are not new but are modified/changed) are updated as shown at 424.

Once this is done, the tool uses an existing tool to generate source code (e.g., ASIL-D level source code) based on the project’s .arxmls, which have been edited to meet the specified architecture, generates C file templates, generates runtime environment, etc. (as shown at 430) and lastly compiles the project and commits the changes to the integration project’s repository (as shown at 432). Whereas the process of creating a new component and adding it to an integration project traditionally requires at least two, often three or possibly more, engineers and at least an hour, if all things go well, of work, these pipelines do all that work automatically in less than ten minutes, with only a single engineer needed to provide the input. And it creates the component within the new development environment that allows it to be easily added to other projects and have changes to it distributed across all projects. Furthermore, there is a reduced need to have multiple licenses for the software tools that generate the ASIL-D source code, since only the server needs to have a set of licenses, rather than numerous users throughout the organization.

These scripts provide a much more streamlined and efficient development process and environment. By offloading the bulk of the software integration work to the server, the overall development time is decreased considerably, with markedly reduced need for expensive licenses for the software tools we rely upon. Furthermore, the work that requires multiple engineers with little to no traceability now can be completed by a single individual, with a full log of changes that can be easily access by all users. And it allows for a more flexible environment, allowing for changes to be readily distributed across several products automatically.

A significant feature of the principles of the present disclosure comes from the described herein process and the development methodology it enables. This means of developing embedded software is radically different than what is traditionally used across multiple industries, and it allows for greater flexibility and development efficiency for all involved. By using a modular approach and allowing changes to be easily applied across multiple projects and product lines, this increases the impact of an individual change by several orders of magnitude. The combination of many distinct parts (e.g. the pipelines triggered on individual commits, organizing projects as a series of submodules that are shared amongst their peers, auto coding individual components, integrating multiple types of software changes, at both the individual component and architectural level) creates a singular process with incredible improvements over the traditional development process.

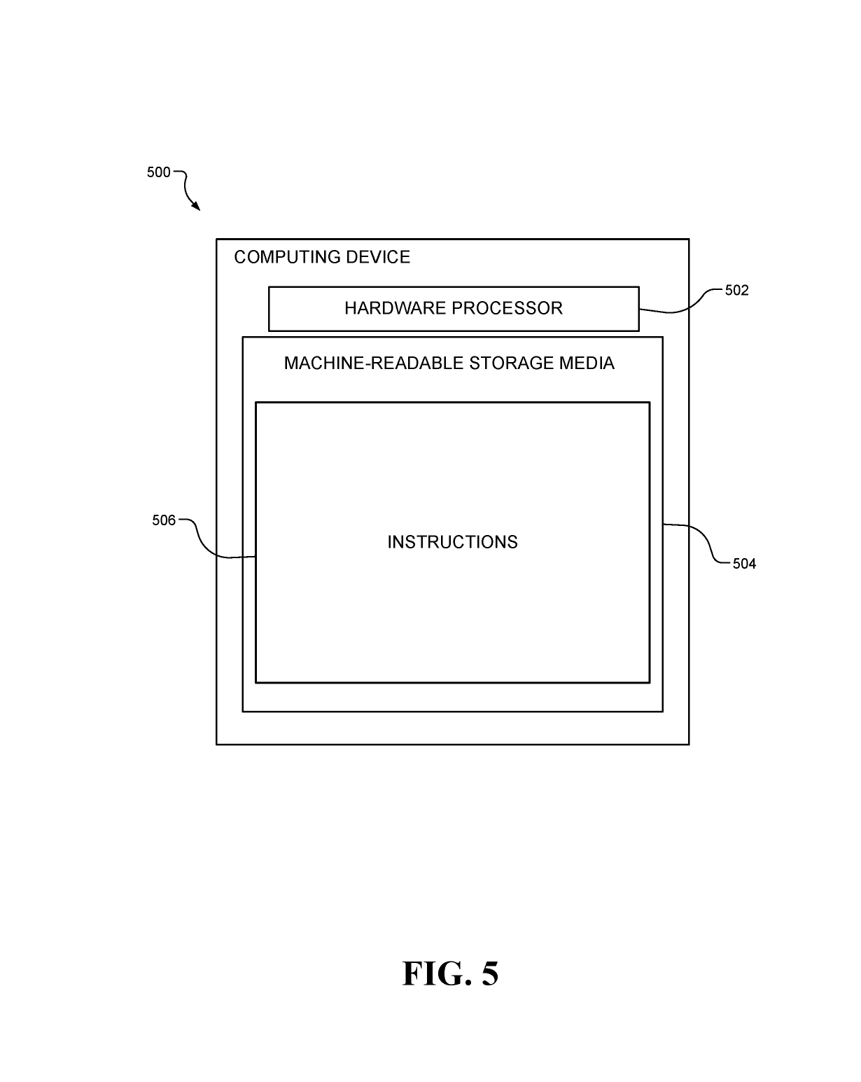

FIG. 5 generally illustrates an example computing device configured to implement various aspects of the pipeline process according to the principles of the present disclosure. The computing device 500 may be, for example, a server computer, a controller, or any other similar computing device capable of processing data. In the example implementation of FIG. 5, computing device 500 includes a hardware processor 502 and machine-readable storage medium 504. The computing device 500 may include one or more additional components, which are not shown to simplify illustration of the computing device 500. For example, the computing device 500 may include a bus or other communication mechanism for communicating information and one or more additional hardware processors coupled with bus for processing information.

The hardware processor 502 may be one or more central processing units (CPUs), semiconductor-based microprocessors, and/or other hardware devices suitable for retrieval and execution of instructions stored in the machine-readable storage medium 504. The hardware processor 502 may fetch, decode, and execute instructions, to control processes or operations for burst preloading for available bandwidth estimation. As an alternative or in addition to retrieving and executing instructions, the hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as the machine-readable storage medium 504, may be any electronic, magnetic, optical, or other physical storage device that contains or stores executable instructions. Thus, the machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some examples, the machine-readable storage medium 504 may be a non-transitory storage medium, where the term "non-transitory" does not encompass transitory propagating signals.

As described in detail below, the machine-readable storage medium 504 may be encoded with executable instructions, such as the instructions 506. Such instructions, when stored in storage media accessible the hardware processor 502, render the computing device 500 into a special-purpose machine that is customized to perform the operations specified in the instructions. Specifically, the instructions 506 may correspond to steps of the example processes shown in FIGS. 3, 4A, and 4B.

In an example, the hardware processor 502 may perform the process shown in FIG. 3 by executing the instructions 506 to: autocode a software model (e.g., of an individual software component of a software product) based on changes made to an individual software component by a user; copy autocoded files (e.g., C and H files) to implementation repositories; generate a component specification file (e.g., create/modify a .arxml file from DataDict repository); commit and push changes to implementation repositories; receive an indication that a change was made to a first software component of the plurality of individual software products (e.g., as triggered by changes being committed and pushed to the implementation repository); in response to the indication, switch the architecture data repository to the correct branch and pull changes; switch all components to the branch specified in the architecture; pull changes for all components in the software product; selectively/automatically update an architecture definition associated with the first software component based on the change made to the first software component; update an architecture of the software product based on the change made to the first software component; compile the software product; commit and push integration project changes; generate a default system configuration project/phase (SCP); and publish build artifacts associated with the software product.

In other examples, the hardware processor 502 may execute the instructions 506 to perform the process shown in FIGS. 4A and 4B.

In some examples, the computing device 500 may be coupled to a display for displaying information to a computer user. One or more input devices may be provided for communicating information and command selections to the hardware processor 502. The computing device 500 may further include a user interface module to implement a GUI that may be stored in a mass storage device as executable software codes that are executed by the computing device. This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computing device 500 may implement the techniques described herein using customized hard-wired logic, one or more ASICs or FPGAs, firmware and/or program logic which in combination with the computer system causes or programs computing device 500 to be a special-purpose machine. According to one example of the disclosed technology, the techniques herein are performed by the computing device 500 in response to the hardware processor 502 executing one or more sequences of one or more instructions contained memory, such as in the machine-readable storage media 504. Execution of the sequences of instructions causes the hardware processor 502 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks. Volatile media includes dynamic memory. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise a bus. Transmission media can also take the form of acoustic or light waves, such as those generated during radio-wave and infra-red data communications.

The computing device 500 may also include a communication interface, such as a network interface providing a two-way data communication coupling to one or more network links that are connected to one or more local networks (e.g., the network 106). For example, the communication interface may be an integrated services digital network (ISDN) card, cable modem, satellite modem, or a modem to provide a data communication connection to a corresponding type of telephone line. As another example, the communication interface may be a local area network (LAN) card to provide a data communication connection to a compatible LAN (or WAN component to communicate with a WAN). Wireless links may also be implemented. In any such implementation, the communication interface sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through the communication interface, which carry the digital data to and from the computing device 500, are example forms of transmission media.

The computing device 500 can send messages and receive data, including program code, through the network(s), network link and communication interface. In the Internet example, a server might transmit a requested code for an application program through the Internet, the ISP, the local network and the communication interface.

The received code may be executed by the hardware processor 502 as it is received, and/or stored in a storage device, or other non-volatile storage for later execution.

Each of the processes, methods, and algorithms described in the preceding sections may be embodied in, and fully or partially automated by, code components executed by one or more computing devices systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as the computing device 500.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

What is claimed is:

1. A method for performing integrated software development of a software product including a plurality of individual software components, the method comprising, using one or more processors:
receiving an indication that a change was made to a first software component of the plurality of individual software products;
in response to the indication, automatically updating an architecture definition associated with the first software component based on the change made to the first software component;
updating an architecture of the software product based on the change made to the first software component;
compiling the software product; and
publishing build artifacts associated with the software product.

2. The method of claim 1, further comprising automatically generating the indication in response to the change being committed to an implementation repository associated with the first software component.

3. The method of claim 1, further comprising auto coding the first software component based on the change.

4. The method of claim 1, further comprising generating a specification component file for the first software component.

5. The method of claim 4, further comprising determining whether the specification component file changed and updating the architecture based on the determination of whether the specification component file changed.

6. The method of claim 1, further comprising:
determining whether a change was made to any of the plurality of individual software components; and
in response to determining that the change was made to any of the plurality of individual software components, updating an architecture of the software product based on the change made to any of the plurality of individual software components.

7. The method of claim 1, wherein the software product corresponds to embedded software of a steering system of a vehicle.

8. A system for performing integrated software development of a software product including a plurality of individual software components, the system comprising:
memory storing instructions; and
one or more processors configured to execute the instructions, wherein executing the instructions causes the system to
receive an indication that a change was made to a first software component of the plurality of individual software products,
in response to the indication, automatically update an architecture definition associated with the first software component based on the change made to the first software component,
update an architecture of the software product based on the change made to the first software component,
compile the software product, and
publish build artifacts associated with the software product.

9. The system of claim 8, wherein executing the instructions further causes the system to automatically generate the indication in response to the change being committed to an implementation repository associated with the first software component.

10. The system of claim 8, wherein executing the instructions further causes the system to auto code the first software component based on the change.

11. The system of claim 8, wherein executing the instructions further causes the system to generate a specification component file for the first software component.

12. The system of claim 11, wherein executing the instructions further causes the system to determine whether the specification component file changed and update the architecture based on the determination of whether the specification component file changed.

13. The system of claim 8, wherein executing the instructions further causes the system to:
determine whether a change was made to any of the plurality of individual software components; and
in response to determining that the change was made to any of the plurality of individual software components, update an architecture of the software product based on the change made to any of the plurality of individual software components.

14. The system of claim 8, wherein the software product corresponds to embedded software of a steering system of a vehicle.

15. A method for performing integrated software development of a software product including a plurality of individual software components, the method comprising, using one or more processors:
receiving an indication that a change was made to an architecture repository associated with the software product;
in response to the indication, comparing a current architecture of the software product with a new architecture corresponding to the change made to the architecture repository;
based on the comparison, automatically modifying the software product by at least one of (i) adding a new software component to the software product, (ii) removing an existing component from the software product, and (iii) modifying an existing component of the software product;
compiling the software product; and
publishing build artifacts associated with the software product.

16. The method of claim 15, wherein automatically modifying the software product includes generating at least one of port mappings and task mappings associated with the change.

17. The method of claim 15, further comprising generating at least one of a C file template and a runtime environment based on the change.

18. The method of claim 15, wherein adding the new software component includes generating a component specification file for the new software component.

19. The method of claim 15, further comprising detecting the change made to the architecture repository and automatically generating the indication based on the detection of the change.

20. The method of claim 15, wherein the software product corresponds to embedded software of a steering system of a vehicle.
